(19) United States
(12) Patent Application Publication
(10) Pub. No.: US 2019/0188386 A1
(43) Pub. Date: Jun. 20, 2019

(54) PROTECTING AI PAYLOADS RUNNING IN GPU AGAINST MAIN CPU RESIDING ADVERSARIES

(71) Applicant: Intel Corporation, Santa Clara, CA (US)

(72) Inventors: Oleg Pogorelik, Jerusalem (IL); Alex Nayshtut, Gan Yaven (IL); Raizy Kellermann, Jerusalem (IL); Venkat Gokulrangan, Portland, OR (US)

(73) Assignee: Intel Corporation, Santa Clara, CA (US)

(21) Appl. No.: 16/233,663

(22) Filed: Dec. 27, 2018

(51) Int. Cl. G06F 21/57; G06F 15/78; G06F 9/54; G06F 21/60; G06N 20/00

(52) U.S. Cl. CPC G06F 21/57; G06F 15/7807; G06N 20/00; G06F 21/602; G06F 9/544

(57) ABSTRACT

Methods and apparatus relating to protecting Artificial Intelligence (AI) payloads running in Graphics Processing Unit (GPU) against main Central Processing Unit (CPU) residing adversaries are described. In an embodiment, memory stores data corresponding to one or more Artificial Intelligence (AI) tasks. The memory comprises at least a shared memory partition and a Graphics Processing Unit (GPU) only memory partition. Logic circuitry performs one or more operations in a protected environment to cause transmission of the stored data from the shared memory partition of the memory to the GPU only memory partition of the memory. The shared memory partition is accessible by both a GPU and a Central Processing Unit (CPU), and the GPU only memory partition is only accessible by the GPU. Other embodiments are also disclosed and claimed.

### FIELD

The present disclosure generally relates to the field of electronics. More particularly, an embodiment relates to protecting Artificial Intelligence (AI) payloads running in Graphics Processing Unit (GPU) against main Central Processing Unit (CPU) residing adversaries.

### BACKGROUND

Machine Learning/Deep Learning (ML/DL) systems are built around so-called models—sophisticated software implementing predictive (probability) functions that map features to a categorical or real-valued output referred by the term “inference”.

In most cases models are occupying large portions of memory and consuming a large amount of computing power for both inference and training (process of crunching the data to create model).

These issues have resulted in a massive shift in development and implementation of the ML/DL run-time payloads to allow them to run on the highly performance Graphics Processing Units (GPUs) which can provide vast amounts of dedicated memory and tremendous parallel compute power.

### BRIEF DESCRIPTION OF THE DRAWINGS

The detailed description is provided with reference to the accompanying figures. In the figures, the left-most digit(s) of a reference number identifies the figure in which the reference number first appears. The use of the same reference numbers in different figures indicates similar or identical items.

FIG. 1 illustrates flow of data in a system to set up AI payloads to run in GPU only environment, according to an embodiment.

FIG. 2 illustrates a block diagram of a system that provides an AI TEE Manager (ATM) high level architecture, according to an embodiment.

FIGS. 3, 4, and 5 illustrate flow diagrams according to some embodiments.

FIGS. 6 and 7 illustrates block diagrams of embodiments of computing systems, which may be utilized in various embodiments discussed herein.

FIGS. 8 and 9 illustrate various components of processers in accordance with some embodiments.

FIG. 10 illustrates a machine learning software stack, according to an embodiment.

FIG. 11 illustrates training and deployment of a deep neural network.

### DETAILED DESCRIPTION

In the following description, numerous specific details are set forth in order to provide a thorough understanding of various embodiments. However, various embodiments may be practiced without the specific details. In other instances, well-known methods, procedures, components, and circuits have not been described in detail so as not to obscure the particular embodiments. Further, various aspects of embodiments may be performed using various means, such as integrated semiconductor circuits (“hardware”), computer-readable instructions organized into one or more programs (“software”), or some combination of hardware and software. For the purposes of this disclosure reference to “logic” shall mean either hardware (such as logic circuitry or more generally circuitry or circuit), software, firmware, or some combination thereof.

As mentioned above, AI payloads are usually mandating heavy parallel computation, best working on a GPU. Unfortunately GPUs usually do not support secure execution/running which forces slow execution in main CPU attached TEE (or Trusted Execution Environment, which can be provided by Intel® Corporation) in cases when high security protection is required. Unfortunately, modern mass production GPUs do not have such an infrastructure. This vulnerability exposes AI payloads running in GPU to the wide set of threats running in the main CPU/processor and accessing graphics shared memory. As a result, when executed in the GPU, Inference and Training engines are left unprotected against tampering and IP (Intellectual Property) theft induced by the adversaries running on the main CPU.

Additionally, the above-mentioned issue brings AI developers to a hard dilemma,—“efficiency vs. security”. In other words, run AI securely (but slow) on a main CPU and protect payload using TEE or run effectively (but unprotected) on GPU taking a risk of model tampering, IP theft or information disclosure caused by the software adversaries running on the main CPU and accessing the GPU's shared memory. Some existing solution such as Protected Audio\Video Path (or PAVP, which is provided by Intel Corporation) were designed to address protection of video content only and no general purpose security (e.g., via TEE) capable GPUs are currently available on the market.

To this end, some embodiments relate to protecting Artificial Intelligence (AI) payloads or tasks running in Graphics Processing Unit (GPU) against main processor or Central Processing Unit (CPU) residing adversaries. As discussed herein, “AI” refers to Artificial Intelligence, but could also generally refer to any parallel processing, compute intensive (e.g., encryption and/or Machine Learning/Deep Learning (ML/DL)), etc. compute payload. One embodiment provides an apparatus for protecting machine and/or deep learning specific payloads running on GPU against software adversaries/code running/executing on main CPU/processor. For example, an existing GPU engine may be augmented with dedicated an AI TEE Manager (ATM). This TEE/ATM component is capable of protecting AI payloads (Inference and Training) in GPU memory during run-time. Another embodiment overcomes TEE memory limitations (usually TEE memory is more limited than GPU's memory).

Further, as discussed herein, a trusted execution environment (TEE) refers to a secure area of a main processor. It guarantees code and data loaded inside to be protected with respect to confidentiality and integrity. A TEE as an isolated execution environment provides security features such as isolated execution, integrity of applications executing with the TEE, along with confidentiality of their assets. In general terms, the TEE offers an execution space that provides a higher level of security than a rich mobile operating system open (mobile OS (Operating System)) and more functionality than a Secure Element (SE). In an embodiment, TEE may be combined with other technologies such as Trusted Platform Module (TPM) technology for enhanced mobile security.

Also, one or more embodiments may be used to provide various operations (e.g., functional safety) for real-time complex systems such as autonomous driving and/or IOT (Internet Of Things) applications in the automotive and industrial segments that may utilize a GPU to perform operations. As discussed herein, a “vehicle” generally refers to any transportation device (whether or not it is capable of being operated autonomously, e.g., with little or no human/driver intervention), such as an automobile, a truck, a motorcycle, an airplane, a helicopter, a vessel/ship, a train, a drone, etc. whether or not the vehicle is a passenger or commercial vehicle, and regardless of the power source type (such as one or more of: fossil fuel(s), solar energy, electric energy, chemical energy, nuclear energy, etc.) and regardless of the physical state of the power source (e.g., solid, liquid, gaseous, etc.) used to move the vehicle. Additionally, while certain embodiments may mention a specific number of components/items, embodiments are not limited to these specific numbers, different or more/less components may be utilized depending on the implementation.

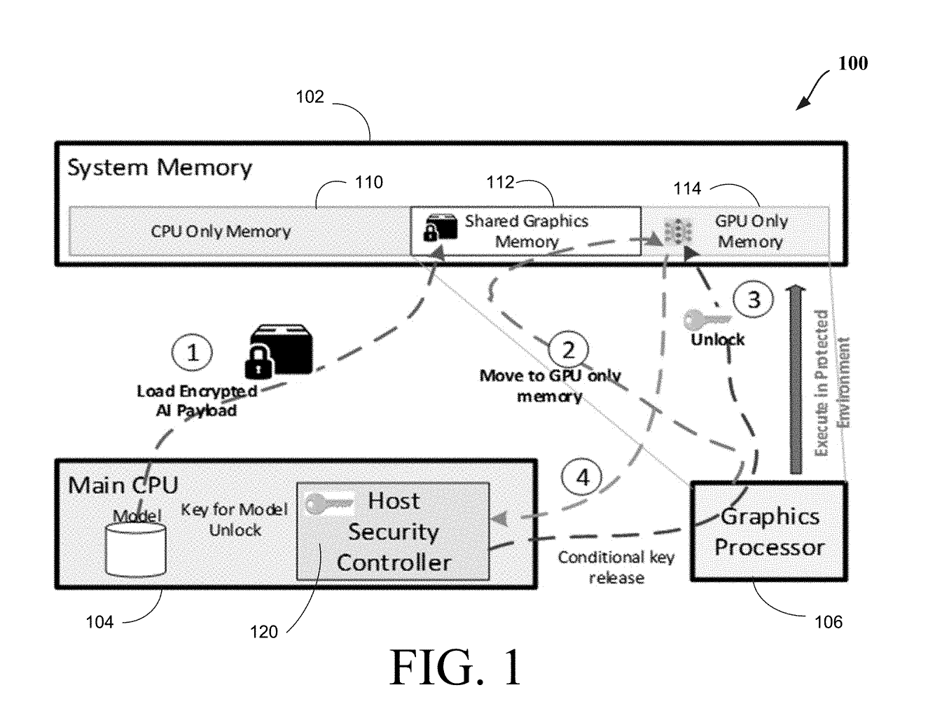

Further, in one embodiment, logic (such the logic of FIGS. 1-6 used for ATM) discussed herein to perform various operations including securing AI tasks (e.g., during runtime) may be included in an IoT device. Moreover, an “IoT” device generally refers to a device which includes electronic processing circuitry (such as one or more processor/cores, PLA (Programmable Logic Array), SoC, ASIC (Application Specific Integrated Circuit), Field Programmable Gate Array (FPGA), etc.), memory (e.g., to store software or firmware), one or more sensors (or is otherwise coupled to one or more sensors such as a camera, motion detector, etc.), and network connectivity to allow the IoT device to collect and/or exchange data. IoT devices can be cheaper than traditional computing devices to allow for their proliferation at remote locations. IoT devices can also reduce costs by using existing infrastructure (such as the Internet, a (third generation (3G), fourth generation (4G), or fifth generation (5G) cellular/wireless network, etc.). More generally, an IoT device may include one or more components such as those discussed herein with reference to the figures.

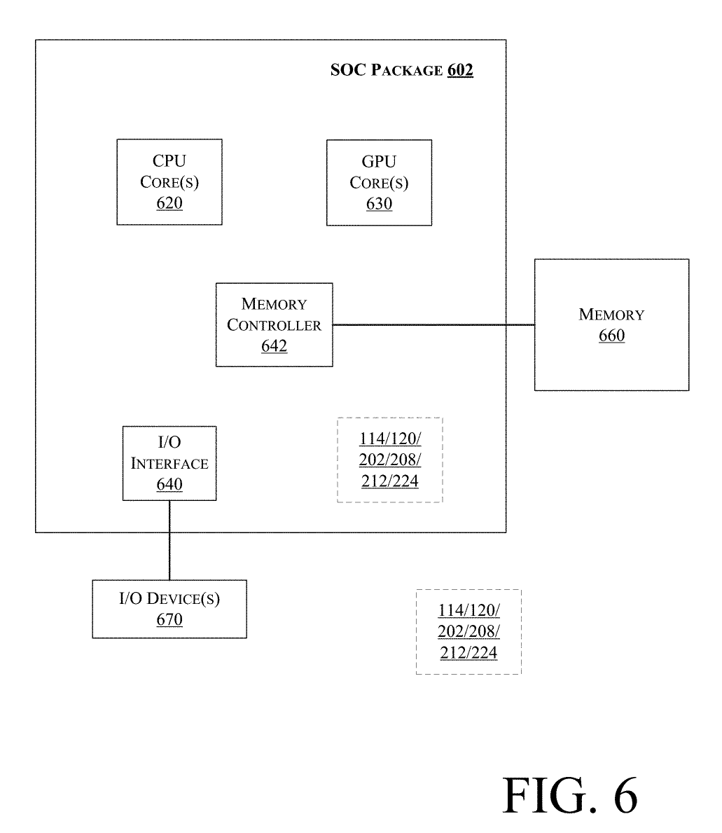

FIG. 1 illustrates flow of data in a system 100 to set up AI payloads to run in GPU only environment, according to an embodiment. As shown, system 100 includes system memory 102, a main CPU/processor 104, and a graphics processor or GPU 106. Memory 102 (which include volatile and/or non-volatile (such as those discussed with reference to FIGS. 6-9)) is partitioned into two or more portions, including for example, a CPU only memory partition 110 (that is only accessible by the main CPU 104), a shared graphics memory partition 112 (that may be accessible by the CPU 104, GPU 106, or other components of the system 100), and/or a GPU only memory partition 114 (which is only accessible by the GPU 106.

In one embodiment, ATM will utilize the capabilities of the hardware system (e.g., system 100) to allocate the GPU only memory 114 (such as supported by BIOS (Basic Input Output System)) that would not be accessible to software (e.g., malware, etc.) running on the main CPU/processor 104. In an embodiment, AI payloads/tasks will only be executed when residing in GPU only memory 114.

For instance, an application will load an encrypted package that includes software engines and related configuration (e.g., network topology settings and model weights, etc.) to the shared graphics memory partition 112, e.g., using dedicated channels (similar to those used by Intel PAVP) supporting new functionality (1). The GPU 106 will then move the information from the shared memory 112 to a protected memory and decrypt it there using a key provided by a security controller/logic 120 (2). The GPU 106 will execute the payload securely using appropriate logic responsible for handling AI payloads (3). Accordingly, the inference results will be encrypted (e.g., using symmetric or asymmetric keys) and provided to a host TEE (e.g., controller/logic 120, which may also reside outside of the main processor in some embodiments) for further handling (4). This actually closes the last gap in end to end security flow. Hence, system 100 allows for AI payloads to run efficiently on a GPU while being as protected as if it is executed in main CPU/processor with security (e.g., TEE) support.

As a result, some embodiments allow for one or more of: (a) acceleration of execution of the AI workloads in GPU while preserving privacy and/or integrity; (b) functional scalability, e.g., easily scale to the other GPU payloads; (c) utilizing/leveraging existing technology and/or infrastructure; and/or (d) strong differentiator for some GPU designs. Furthermore, one or more embodiments are focused on: an apparatus to support trusted execution of the AI payloads, the definition of the related interfaces, and/or the definitions of the control flow.

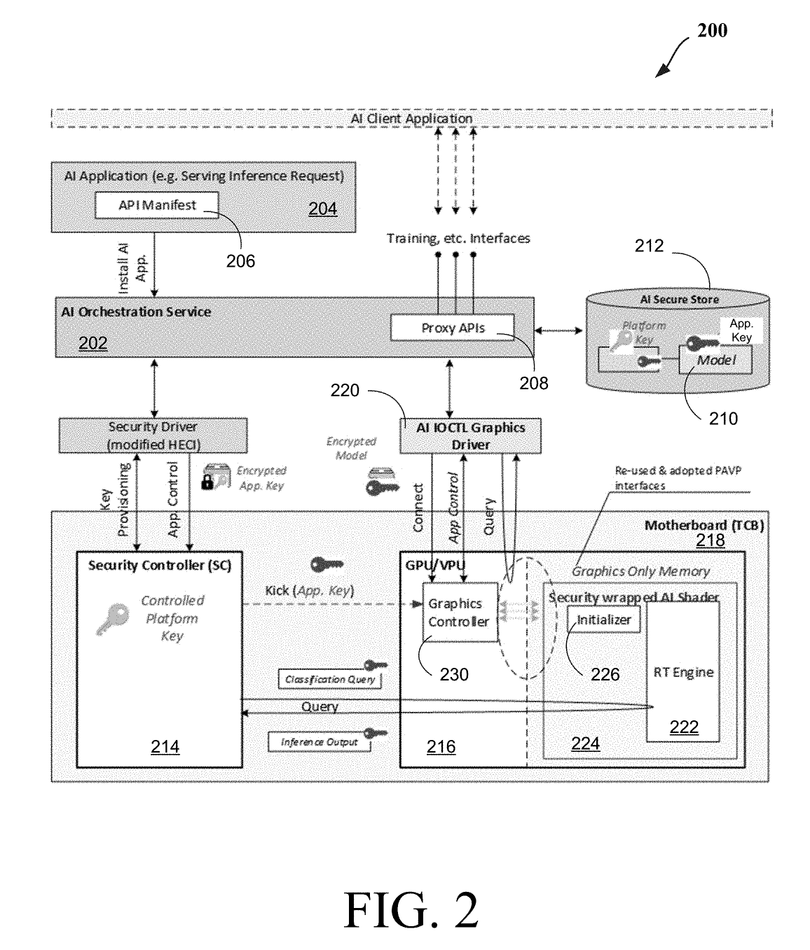

FIG. 2 illustrates a block diagram of a system 200 that provides an AI TEE Manager (ATM) high level architecture, according to an embodiment. System 200 includes various components as discussed in more detail below.

AI Orchestration Service/Logic 202—this is a service responsible for installation of the AI components and handling application specific AI queries related to inference and/or training. An AI Application 204 will be prepared to provide information about its interfaces (e.g., using an Application Program Interface (API) manifest 206) to assist service in exposing appropriate proxy APIs 208 after installation is completed. As a part of installation, AI Orchestration Service/Logic 202 will encrypt the Model 210 (shown in example) and save it in dedicated security store 212 (which may include memory such as those discussed with reference to FIGS. 6-9). Model 210 will be encrypted using unique application specific key, while the key itself may be encrypted using platform key managed by Security controller/logic 214 (which may be the same as or similar to the host security controller/logic 110 of FIG. 1). Security controller logic 214 enforces key generation, model encryption, and/or key exchange between security controller 214 and GPU 216 (which may be the same or similar to the GPU 96 of FIG. 1). As shown in FIG. 2, a motherboard 218 (or Trusted Computer Based (TCB)) may include the GPU 216 (which may be a Vector Processing Unit (VPU) in some embodiments).

API Proxy Forwarder/Logic 208—this is the logic block responsible for transferring application initiated queries to the protected service through the (e.g., dedicated) AI GPU Driver 220 APIs while enforcing protection of the AI payload. Proxy Forwarder logic is used for forwarding regular inference calls to either “normal” (e.g., general-purpose) or graphic execution unit. Proxy is hiding implementation details, so that the API caller would not have to deal with the mentioned details. Proxy Forwarder logic will be configured to forward calls in accordance with some logic (e.g., picking the best execution unit if available and meet predefined criteria).

API Security Store 212—this memory provides a protected AI repository allowing easy access and loading of the AI payloads to GPU memory (such as memory partition 104 of FIG. 1) and/or enforcing application access policies.

RT (Run Time) Engine/Logic 222—this is an inference/training engine including dedicated software complemented by the related settings (such as network topology configuration and weights) adopted to GPU instructions code, memory, multi-threading, etc.

AI IO (Input/Output) CTL (Control/Controller) to Graphics Driver/Logic 220—this is the kernel mode driver exposing appropriate interfaces for activating AI payload in the GPU only (i.e., which is protected as discussed before) memory, application RT control, as well as query forwarding back and force.

Security Wrapped AI Shader/Logic 224—this is a dedicated new block implementing AI payload specific logic including Initialization and handling appropriate queries. AI Shader will include the following parts: (1) Model Initializer 226—which is a subsystem running in GPU only memory and responsible for initiating AI specific payload. After being provided with App. Key, the initializer 226 copies the encrypted model from the shared memory to the GPU only memory, decrypt it, and prepares it in memory to run/execute. Decrypted content will be stored in GPU only memory. After placing the model, the GPU TEE Initializer 226 will notify Inference Proxy Forwarder about service availability. (2) RT Engine 222—which is the subsystem for managing smooth queries processing, including queueing, prioritization, handling exceptions, etc. As mentioned earlier, the AI Shader 224 will run in GPU Only memory.

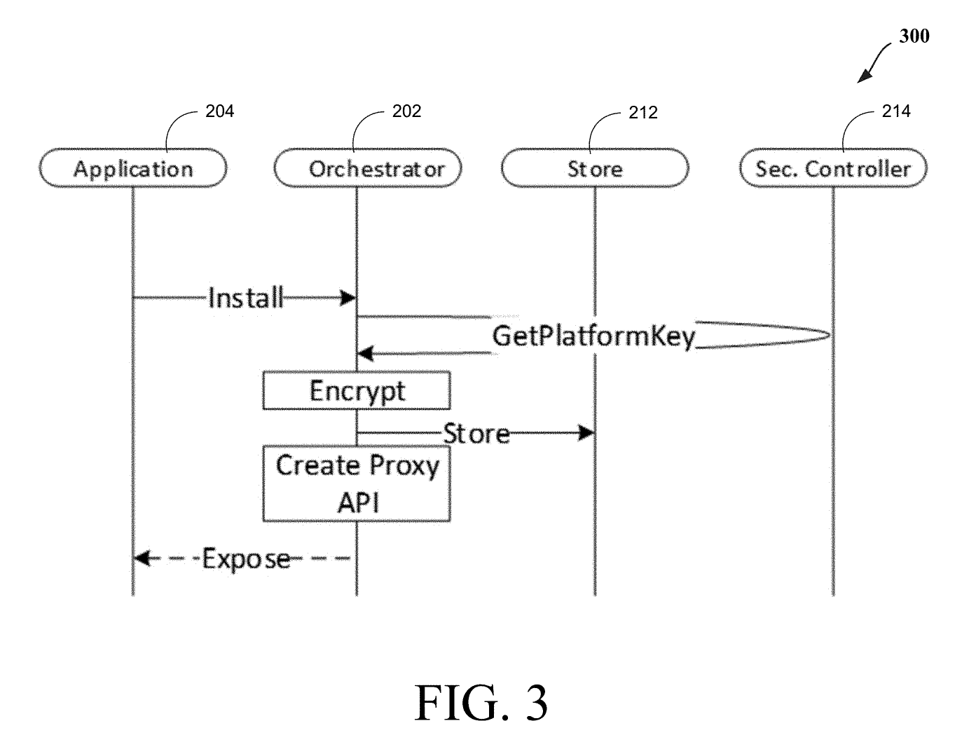

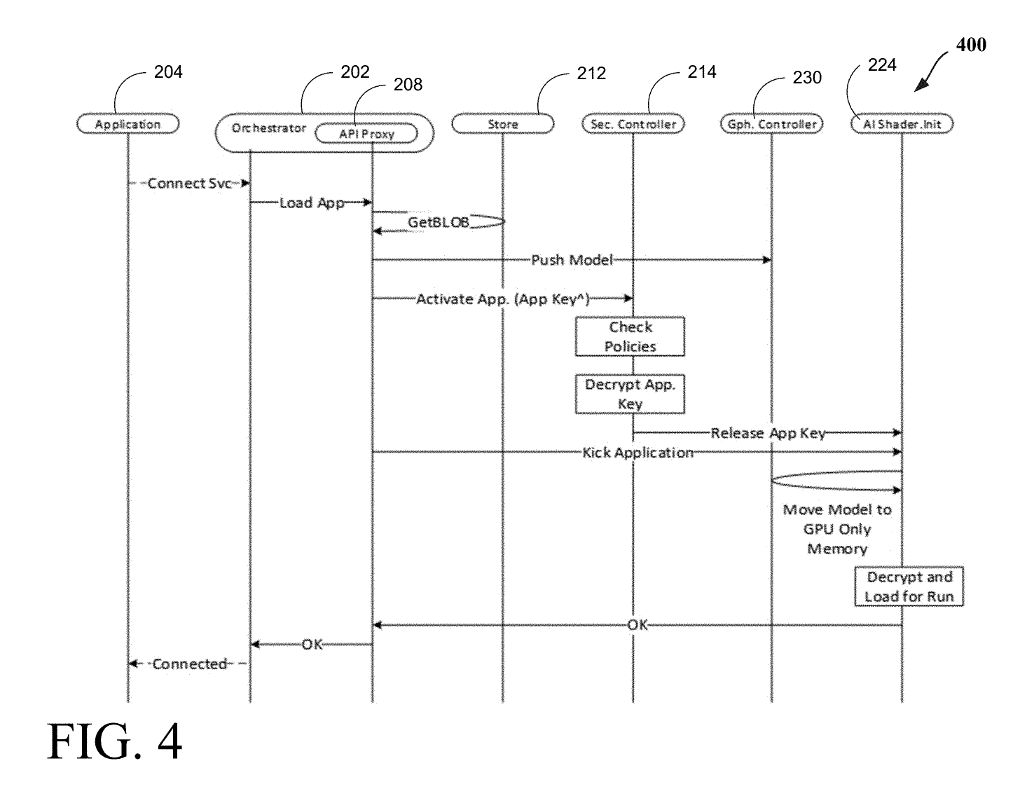

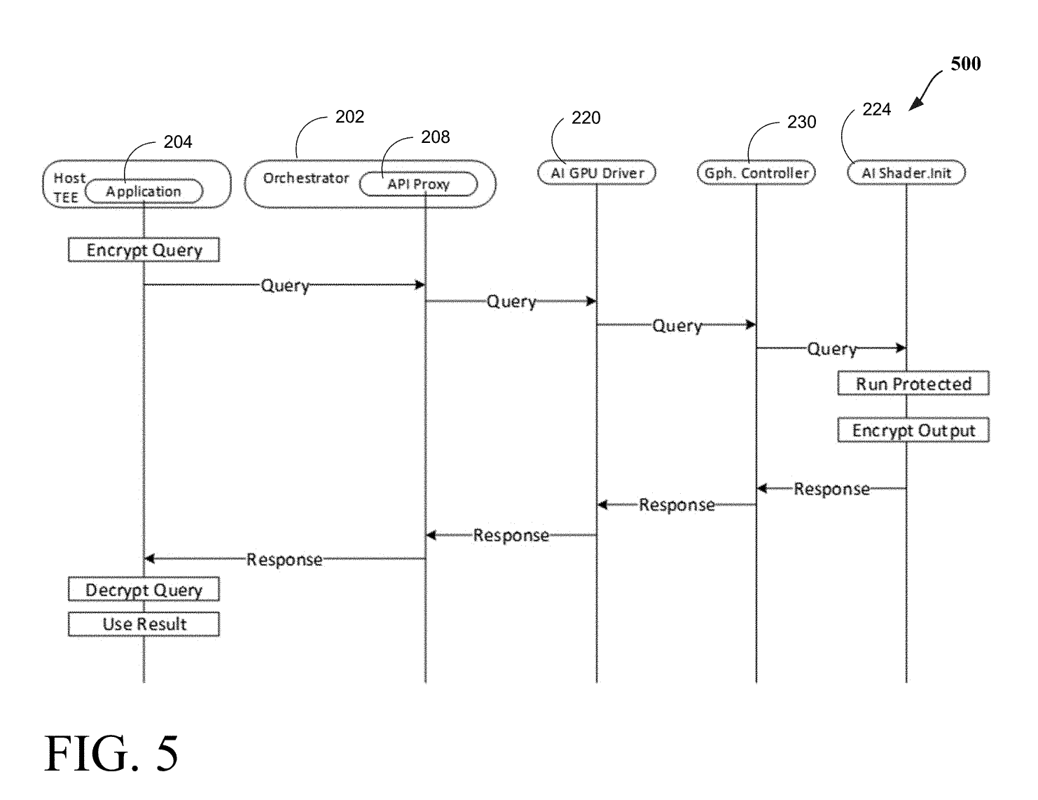

FIG. 3 illustrates a flow diagram for a method 300 to install an application, according to an embodiment. FIG. 4 illustrates a flow diagram for a method 400 to initialize an application, according to an embodiment. FIG. 5 illustrates a flow diagram for a method 500 for query handling, according to an embodiment. In various embodiments, one or more components of FIGS. 1-2 and/or 6-9 may be used to perform one or more of the operations of FIGS. 3-5.

Referring to FIG. 3, application 204 sends a signal to the AI Orchestrator Service/Logic 202 to install AI component(s). The AI Orchestrator Service/Logic 202 then obtains a platform key from the security controller 214, encrypts it, stores it in the store 212, creates/generates a corresponding proxy API 208, and exposes the generated API to the application 204.

Referring to FIG. 4, application 204 initializes by issuing a signal to initialize (e.g., connect) service to AI Orchestrator Service/Logic 202. AI Orchestrator Service/Logic 202 loads a corresponding app into the API proxy 208. API proxy 208 then obtains BLOB (or Block of Binary data—usually meant that the data is binary and should be handled as a sequence of bits) from the AI secure store 212, pushes the obtained model to graphics controller 230, and activates the app key to the security controller 214. In response to the activated app key, the security controller 214 checks one or more policies and decrypts the app key. The security controller 214 then releases the decrypted app key to the AI shader 224. Subsequently, the API proxy 208 kicks the application to the AI shader 224 (e.g., to initialize the application, where “kick” refers to the activation of the shader or opening it for serving requests after initialization completion). In response, the AI shader 224 moves the model to the GPU only memory partition (e.g., partition 104 of FIG. 1), and decrypts/loads the decrypted model for run/execution. The AI shader 224 then sends an acknowledgement signal (e.g., OK) to the API proxy 208. In turn the API proxy sends an acknowledgement to the AI Orchestrator Service/Logic 202 who in turn sends a confirmation regarding the initialization of the application (e.g., “connected”) to the application 204.

Referring to FIG. 5, application 204 (which may be implemented as part of the host TEE as mentioned before) encrypts a query and sends it to the API proxy 208. The query is then forwarded to the AI GPU driver 220, graphics controller, and finally AI shader 224. AI shader 224 runs the query in protected mode and encrypts the resulting output to generate a response. The response then is passed to the graphics controller 230, AI GPU driver 220, API proxy 208, and finally to the application 204. The application 204 then decrypts the received response and uses the result.

FIG. 6 illustrates a block diagram of an SOC package in accordance with an embodiment. As illustrated in FIG. 6, SOC 602 includes one or more Central Processing Unit (CPU) cores 620, one or more Graphics Processor Unit (GPU) cores 630, an Input/Output (I/O) interface 640, and a memory controller 642. Various components of the SOC package 602 may be coupled to an interconnect or bus such as discussed herein with reference to the other figures. Also, the SOC package 602 may include more or less components, such as those discussed herein with reference to the other figures. Further, each component of the SOC package 602 may include one or more other components, e.g., as discussed with reference to the other figures herein. In one embodiment, SOC package 602 (and its components) is provided on one or more Integrated Circuit (IC) die, e.g., which are packaged into a single semiconductor device.

As illustrated in FIG. 6, SOC package 602 is coupled to a memory 660 via the memory controller 642. In an embodiment, the memory 660 (or a portion of it) can be integrated on the SOC package 602.

The I/O interface 640 may be coupled to one or more I/O devices 670, e.g., via an interconnect and/or bus such as discussed herein with reference to other figures. I/O device(s) 670 may include one or more of a keyboard, a mouse, a touchpad, a display, an image/video capture device (such as a camera or camcorder/video recorder), a touch screen, a speaker, or the like.

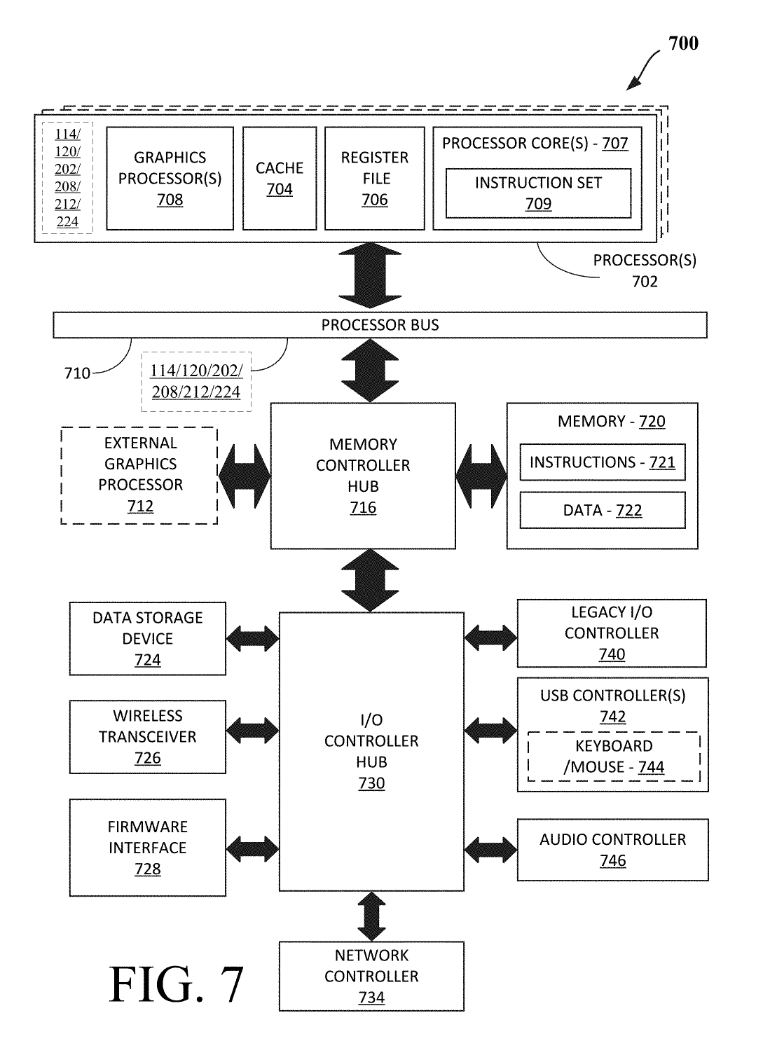

FIG. 7 is a block diagram of a processing system 700, according to an embodiment. In various embodiments the system 700 includes one or more processors 702 and one or more graphics processors 708, and may be a single processor desktop system, a multiprocessor workstation system, or a server system having a large number of processors 702 or processor cores 707. In on embodiment, the system 700 is a processing platform incorporated within a system-on-a-chip (SoC or SOC) integrated circuit for use in mobile, handheld, or embedded devices.

An embodiment of system 700 can include, or be incorporated within a server-based gaming platform, a game console, including a game and media console, a mobile gaming console, a handheld game console, or an online game console. In some embodiments system 700 is a mobile phone, smart phone, tablet computing device or mobile Internet device. Data processing system 700 can also include, couple with, or be integrated within a wearable device, such as a smart watch wearable device, smart eyewear device, augmented reality device, or virtual reality device. In some embodiments, data processing system 700 is a television or set top box device having one or more processors 702 and a graphical interface generated by one or more graphics processors 708.

In some embodiments, the one or more processors 702 each include one or more processor cores 707 to process instructions which, when executed, perform operations for system and user software. In some embodiments, each of the one or more processor cores 707 is configured to process a specific instruction set 709. In some embodiments, instruction set 709 may facilitate Complex Instruction Set Computing (CISC), Reduced Instruction Set Computing (RISC), or computing via a Very Long Instruction Word (VLIW). Multiple processor cores 707 may each process a different instruction set 709, which may include instructions to facilitate the emulation of other instruction sets. Processor core 707 may also include other processing devices, such a Digital Signal Processor (DSP).

In some embodiments, the processor 702 includes cache memory 704. Depending on the architecture, the processor 702 can have a single internal cache or multiple levels of internal cache. In some embodiments, the cache memory is shared among various components of the processor 702. In some embodiments, the processor 702 also uses an external cache (e.g., a Level-3 (L3) cache or Last Level Cache (LLC)) (not shown), which may be shared among processor cores 707 using known cache coherency techniques. A register file 706 is additionally included in processor 702 which may include different types of registers for storing different types of data (e.g., integer registers, floating point registers, status registers, and an instruction pointer register). Some registers may be general-purpose registers, while other registers may be specific to the design of the processor 702.

In some embodiments, processor 702 is coupled to a processor bus 710 to transmit communication signals such as address, data, or control signals between processor 702 and other components in system 700. In one embodiment the system 700 uses an exemplary ‘hub’ system architecture, including a memory controller hub 716 and an Input Output (I/O) controller hub 730. A memory controller hub 716 facilitates communication between a memory device and other components of system 700, while an I/O Controller Hub (ICH) 730 provides connections to I/O devices via a local I/O bus. In one embodiment, the logic of the memory controller hub 716 is integrated within the processor.

Memory device 720 can be a dynamic random access memory (DRAM) device, a static random access memory (SRAM) device, flash memory device, phase-change memory device, or some other memory device having suitable performance to serve as process memory. In one embodiment the memory device 720 can operate as system memory for the system 700, to store data 722 and instructions 721 for use when the one or more processors 702 executes an application or process. Memory controller hub 716 also couples with an optional external graphics processor 712, which may communicate with the one or more graphics processors 708 in processors 702 to perform graphics and media operations.

In some embodiments, ICH 730 enables peripherals to connect to memory device 720 and processor 702 via a high-speed I/O bus. The I/O peripherals include, but are not limited to, an audio controller 746, a firmware interface 728, a wireless transceiver 726 (e.g., Wi-Fi, Bluetooth), a data storage device 724 (e.g., hard disk drive, flash memory, etc.), and a legacy I/O controller 740 for coupling legacy (e.g., Personal System 2 (PS/2)) devices to the system. One or more Universal Serial Bus (USB) controllers 742 connect input devices, such as keyboard and mouse 744 combinations. A network controller 734 may also couple to ICH 730. In some embodiments, a high-performance network controller (not shown) couples to processor bus 710. It will be appreciated that the system 700 shown is exemplary and not limiting, as other types of data processing systems that are differently configured may also be used. For example, the I/O controller hub 730 may be integrated within the one or more processor 702, or the memory controller hub 716 and I/O controller hub 730 may be integrated into a discreet external graphics processor, such as the external graphics processor 712.

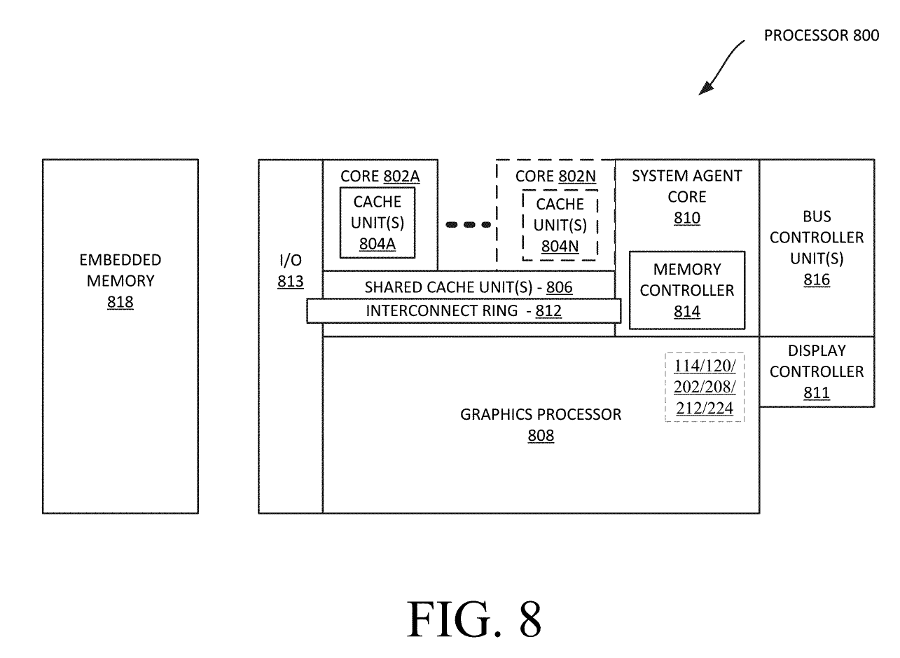

FIG. 8 is a block diagram of an embodiment of a processor 800 having one or more processor cores 802A to 802N, an integrated memory controller 814, and an integrated graphics processor 808. Those elements of FIG. 8 having the same reference numbers (or names) as the elements of any other figure herein can operate or function in any manner similar to that described elsewhere herein, but are not limited to such. Processor 800 can include additional cores up to and including additional core 802N represented by the dashed lined boxes. Each of processor cores 802A to 802N includes one or more internal cache units 804A to 804N. In some embodiments each processor core also has access to one or more shared cached units 806.

The internal cache units 804A to 804N and shared cache units 806 represent a cache memory hierarchy within the processor 800. The cache memory hierarchy may include at least one level of instruction and data cache within each processor core and one or more levels of shared mid-level cache, such as a Level 2 (L2), Level 3 (L3), Level 4 (L4), or other levels of cache, where the highest level of cache before external memory is classified as the LLC. In some embodiments, cache coherency logic maintains coherency between the various cache units 806 and 804A to 804N.

In some embodiments, processor 800 may also include a set of one or more bus controller units 816 and a system agent core 810. The one or more bus controller units 816 manage a set of peripheral buses, such as one or more Peripheral Component Interconnect buses (e.g., PCI, PCI Express). System agent core 810 provides management functionality for the various processor components. In some embodiments, system agent core 810 includes one or more integrated memory controllers 814 to manage access to various external memory devices (not shown).

In some embodiments, one or more of the processor cores 802A to 802N include support for simultaneous multi-threading. In such embodiment, the system agent core 810 includes components for coordinating and operating cores 802A to 802N during multi-threaded processing. System agent core 810 may additionally include a power control unit (PCU), which includes logic and components to regulate the power state of processor cores 802A to 802N and graphics processor 808.

In some embodiments, processor 800 additionally includes graphics processor 808 to execute graphics processing operations. In some embodiments, the graphics processor 808 couples with the set of shared cache units 806, and the system agent core 810, including the one or more integrated memory controllers 814. In some embodiments, a display controller 811 is coupled with the graphics processor 808 to drive graphics processor output to one or more coupled displays. In some embodiments, display controller 811 may be a separate module coupled with the graphics processor via at least one interconnect, or may be integrated within the graphics processor 808 or system agent core 810.

In some embodiments, a ring based interconnect unit 812 is used to couple the internal components of the processor 800. However, an alternative interconnect unit may be used, such as a point-to-point interconnect, a switched interconnect, or other techniques, including techniques well known in the art. In some embodiments, graphics processor 808 couples with the ring interconnect 812 via an I/O link 813.

The exemplary I/O link 813 represents at least one of multiple varieties of I/O interconnects, including an on package I/O interconnect which facilitates communication between various processor components and a high-performance embedded memory module 818, such as an eDRAM (or embedded DRAM) module. In some embodiments, each of the processor cores 802 to 802N and graphics processor 808 use embedded memory modules 818 as a shared Last Level Cache.

In some embodiments, processor cores 802A to 802N are homogenous cores executing the same instruction set architecture. In another embodiment, processor cores 802A to 802N are heterogeneous in terms of instruction set architecture (ISA), where one or more of processor cores 802A to 802N execute a first instruction set, while at least one of the other cores executes a subset of the first instruction set or a different instruction set. In one embodiment processor cores 802A to 802N are heterogeneous in terms of microarchitecture, where one or more cores having a relatively higher power consumption couple with one or more power cores having a lower power consumption. Additionally, processor 800 can be implemented on one or more chips or as an SoC integrated circuit having the illustrated components, in addition to other components.

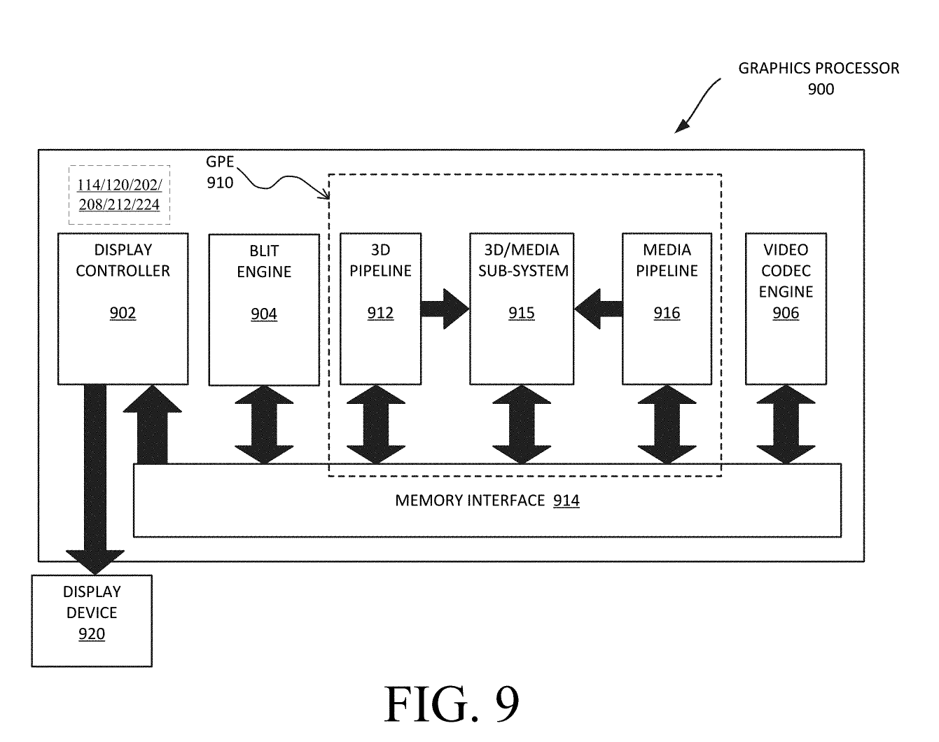

FIG. 9 is a block diagram of a graphics processor 900, which may be a discrete graphics processing unit, or may be a graphics processor integrated with a plurality of processing cores. In some embodiments, the graphics processor communicates via a memory mapped I/O interface to registers on the graphics processor and with commands placed into the processor memory. In some embodiments, graphics processor 900 includes a memory interface 914 to access memory. Memory interface 914 can be an interface to local memory, one or more internal caches, one or more shared external caches, and/or to system memory.

In some embodiments, graphics processor 900 also includes a display controller 902 to drive display output data to a display device 920. Display controller 902 includes hardware for one or more overlay planes for the display and composition of multiple layers of video or user interface elements. In some embodiments, graphics processor 900 includes a video codec engine 906 to encode, decode, or transcode media to, from, or between one or more media encoding formats, including, but not limited to Moving Picture Experts Group (MPEG) formats such as MPEG-2, Advanced Video Coding (AVC) formats such as H.264/MPEG-4 AVC, as well as the Society of Motion Picture & Television Engineers (SMPTE) 321M/VC-1, and Joint Photographic Experts Group (JPEG) formats such as JPEG, and Motion JPEG (MJPEG) formats.

In some embodiments, graphics processor 900 includes a block image transfer (BLIT) engine 904 to perform two-dimensional (2D) rasterizer operations including, for example, bit-boundary block transfers. However, in one embodiment, 9D graphics operations are performed using one or more components of graphics processing engine (GPE) 910. In some embodiments, graphics processing engine 910 is a compute engine for performing graphics operations, including three-dimensional (3D) graphics operations and media operations.

In some embodiments, GPE 910 includes a 3D pipeline 912 for performing 3D operations, such as rendering three-dimensional images and scenes using processing functions that act upon 3D primitive shapes (e.g., rectangle, triangle, etc.). The 3D pipeline 912 includes programmable and fixed function elements that perform various tasks within the element and/or spawn execution threads to a 3D/Media sub-system 915. While 3D pipeline 912 can be used to perform media operations, an embodiment of GPE 910 also includes a media pipeline 916 that is specifically used to perform media operations, such as video post-processing and image enhancement.

In some embodiments, media pipeline 916 includes fixed function or programmable logic units to perform one or more specialized media operations, such as video decode acceleration, video de-interlacing, and video encode acceleration in place of, or on behalf of video codec engine 906. In some embodiments, media pipeline 916 additionally includes a thread spawning unit to spawn threads for execution on 3D/Media sub-system 915. The spawned threads perform computations for the media operations on one or more graphics execution units included in 3D/Media sub-system 915.

In some embodiments, 3D/Media subsystem 915 includes logic for executing threads spawned by 3D pipeline 912 and media pipeline 916. In one embodiment, the pipelines send thread execution requests to 3D/Media subsystem 915, which includes thread dispatch logic for arbitrating and dispatching the various requests to available thread execution resources. The execution resources include an array of graphics execution units to process the 3D and media threads. In some embodiments, 3D/Media subsystem 915 includes one or more internal caches for thread instructions and data. In some embodiments, the subsystem also includes shared memory, including registers and addressable memory, to share data between threads and to store output data.

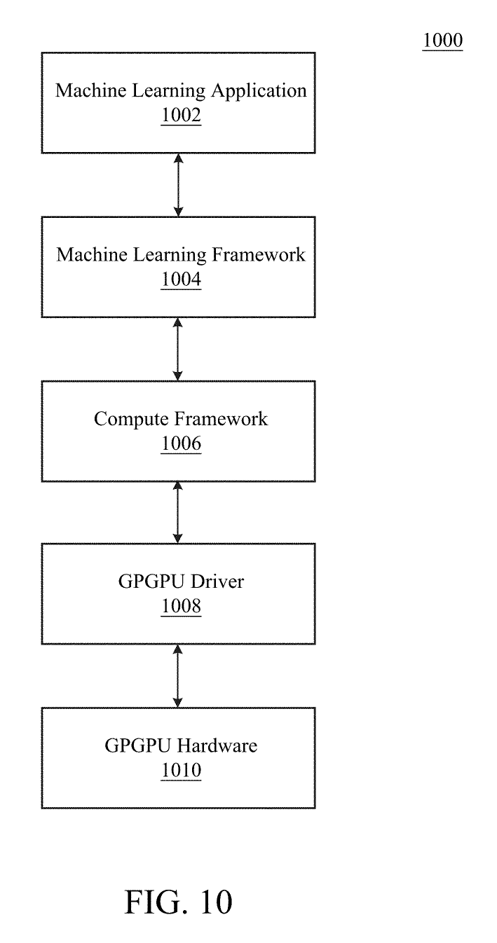

One or more embodiments are aimed to address AI specific security objectives by focusing on secure execution of AI operands including Convolutional Neural Network (CNN) or Deep Neural Network (DNN) convolution primitives in GPU without needing an intermediary. More particularly, FIG. 10 is a generalized diagram of a machine learning software stack 1000. A machine learning application 1002 can be configured to train a neural network or other similar supervised machine learning techniques using a training dataset or to use a trained deep neural network to implement machine intelligence. Moreover, while one or more embodiments are discussed herein with reference to heavy deep learning implementations, embodiments are not limited to such implementations and any supervised machine learning algorithm can be used, such as Bayesian Network (also referred to as Bayes Net), Random Forest, Logistic Regression, SVM (Support Vector Machine), Neural Network, Deep Neural Network, or any combinations thereof. The machine learning application 1002 can include training and inference functionality for a neural network and/or specialized software that can be used to train a neural network before deployment. The machine learning application 1002 can implement any type of machine intelligence including but not limited to image recognition, mapping and localization, autonomous navigation, speech synthesis, medical imaging, or language translation.

Hardware acceleration for the machine learning application 1002 can be enabled via a machine learning framework 1004. The machine learning framework 1004 can provide a library of machine learning primitives. Machine learning primitives are basic operations that are commonly performed by machine learning algorithms. Without the machine learning framework 1004, developers of machine learning algorithms would be required to create and optimize the main computational logic associated with the machine learning algorithm, then re-optimize the computational logic as new parallel processors are developed. Instead, the machine learning application can be configured to perform the necessary computations using the primitives provided by the machine learning framework 1004. Exemplary primitives include tensor convolutions, activation functions, and pooling, which are computational operations that are performed while training a Convolutional Neural Network (CNN). The machine learning framework 1004 can also provide primitives to implement basic linear algebra subprograms performed by many machine-learning algorithms, such as matrix and vector operations.

The machine learning framework 1004 can process input data received from the machine learning application 1002 and generate the appropriate input to a compute framework 1006. The compute framework 1006 can abstract the underlying instructions provided to the GPGPU driver 1008 to enable the machine learning framework 1004 to take advantage of hardware acceleration via the GPGPU hardware 1010 without requiring the machine learning framework 1004 to have intimate knowledge of the architecture of the GPGPU hardware 1010. Additionally, the compute framework 1006 can enable hardware acceleration for the machine learning framework 1004 across a variety of types and generations of the GPGPU hardware 1010.

The computing architecture provided by embodiments described herein can be configured to perform the types of parallel processing that is particularly suited for training and deploying neural networks for machine learning. A neural network can be generalized as a network of functions having a graph relationship. As is known in the art, there are a variety of types of neural network implementations used in machine learning. One exemplary type of neural network is the feedforward network, as previously described.

A second exemplary type of neural network is the Convolutional Neural Network (CNN). A CNN is a specialized feedforward neural network for processing data having a known, grid-like topology, such as image data. Accordingly, CNNs are commonly used for compute vision and image recognition applications, but they also may be used for other types of pattern recognition such as speech and language processing. The nodes in the CNN input layer are organized into a set of “filters” (feature detectors inspired by the receptive fields found in the retina), and the output of each set of filters is propagated to nodes in successive layers of the network. The computations for a CNN include applying the convolution mathematical operation to each filter to produce the output of that filter. Convolution is a specialized kind of mathematical operation performed by two functions to produce a third function that is a modified version of one of the two original functions. In convolutional network terminology, the first function to the convolution can be referred to as the input, while the second function can be referred to as the convolution kernel. The output may be referred to as the feature map. For example, the input to a convolution layer can be a multidimensional array of data that defines the various color components of an input image. The convolution kernel can be a multidimensional array of parameters, where the parameters are adapted by the training process for the neural network.

Recurrent neural networks (RNNs) are a family of feedforward neural networks that include feedback connections between layers. RNNs enable modeling of sequential data by sharing parameter data across different parts of the neural network. The architecture for a RNN includes cycles. The cycles represent the influence of a present value of a variable on its own value at a future time, as at least a portion of the output data from the RNN is used as feedback for processing subsequent input in a sequence. This feature makes RNNs particularly useful for language processing due to the variable nature in which language data can be composed.

The figures described herein present exemplary feedforward, CNN, and RNN networks, as well as describe a general process for respectively training and deploying each of those types of networks. It will be understood that these descriptions are exemplary and non-limiting as to any specific embodiment described herein and the concepts illustrated can be applied generally to deep neural networks and machine learning techniques in general.

The exemplary neural networks described above can be used to perform deep learning. Deep learning is machine learning using deep neural networks. The deep neural networks used in deep learning are artificial neural networks composed of multiple hidden layers, as opposed to shallow neural networks that include only a single hidden layer. Deeper neural networks are generally more computationally intensive to train. However, the additional hidden layers of the network enable multistep pattern recognition that results in reduced output error relative to shallow machine learning techniques.

Deep neural networks used in deep learning typically include a front-end network to perform feature recognition coupled to a back-end network which represents a mathematical model that can perform operations (e.g., object classification, speech recognition, etc.) based on the feature representation provided to the model. Deep learning enables machine learning to be performed without requiring hand crafted feature engineering to be performed for the model. Instead, deep neural networks can learn features based on statistical structure or correlation within the input data. The learned features can be provided to a mathematical model that can map detected features to an output. The mathematical model used by the network is generally specialized for the specific task to be performed, and different models will be used to perform different task.

Once the neural network is structured, a learning model can be applied to the network to train the network to perform specific tasks. The learning model describes how to adjust the weights within the model to reduce the output error of the network. Backpropagation of errors is a common method used to train neural networks. An input vector is presented to the network for processing. The output of the network is compared to the desired output using a loss function and an error value is calculated for each of the neurons in the output layer. The error values are then propagated backwards until each neuron has an associated error value which roughly represents its contribution to the original output. The network can then learn from those errors using an algorithm, such as the stochastic gradient descent algorithm, to update the weights of the of the neural network.

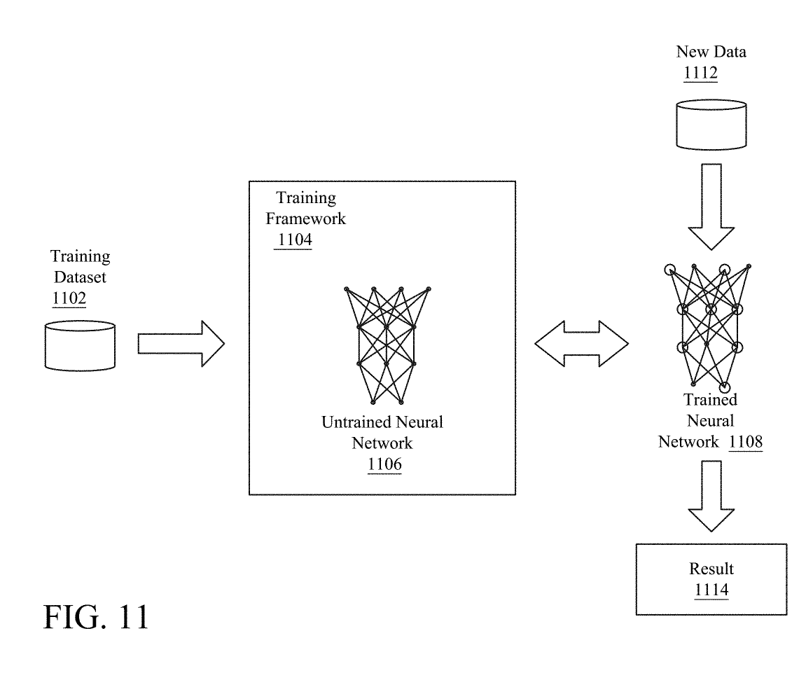

FIG. 11 illustrates training and deployment of a deep neural network. Once a given network has been structured for a task the neural network is trained using a training dataset 1102. Various training frameworks have been developed to enable hardware acceleration of the training process. For example, the machine learning framework 1004 of FIG. 10 may be configured as a training framework 1104. The training framework 1104 can hook into an untrained neural network 1106 and enable the untrained neural net to be trained using the parallel processing resources described herein to generate a trained neural network 1108. To start the training process the initial weights may be chosen randomly or by pre-training using a deep belief network. The training cycle then be performed in either a supervised or unsupervised manner.

Supervised learning is a learning method in which training is performed as a mediated operation, such as when the training dataset 1102 includes input paired with the desired output for the input, or where the training dataset includes input having known output and the output of the neural network is manually graded. The network processes the inputs and compares the resulting outputs against a set of expected or desired outputs. Errors are then propagated back through the system. The training framework 1104 can adjust to adjust the weights that control the untrained neural network 1106. The training framework 1104 can provide tools to monitor how well the untrained neural network 1106 is converging towards a model suitable to generating correct answers based on known input data. The training process occurs repeatedly as the weights of the network are adjusted to refine the output generated by the neural network. The training process can continue until the neural network reaches a statistically desired accuracy associated with a trained neural network 1108. The trained neural network 1108 can then be deployed as result 1114 to implement any number of machine learning operations.

Unsupervised learning is a learning method in which the network attempts to train itself using unlabeled data. Thus, for unsupervised learning the training dataset 1102 will include input data without any associated output data. The untrained neural network 1106 can learn groupings within the unlabeled input and can determine how individual inputs are related to the overall dataset. Unsupervised training can be used to generate a self-organizing map, which is a type of trained neural network 1107 capable of performing operations useful in reducing the dimensionality of data. Unsupervised training can also be used to perform anomaly detection, which allows the identification of data points in an input dataset that deviate from the normal patterns of the data.

Variations on supervised and unsupervised training may also be employed. Semi-supervised learning is a technique in which in the training dataset 1102 includes a mix of labeled and unlabeled data of the same distribution. Incremental learning is a variant of supervised learning in which input data is continuously used to further train the model. Incremental learning enables the trained neural network 1108 to adapt to the new data 1112 without forgetting the knowledge instilled within the network during initial training.

Whether supervised or unsupervised, the training process for particularly deep neural networks may be too computationally intensive for a single compute node. Instead of using a single compute node, a distributed network of computational nodes can be used to accelerate the training process.

The following examples pertain to further embodiments. Example 1 includes an apparatus comprising: memory store data corresponding to one or more Artificial Intelligence (AI) tasks, wherein the memory comprises at least a shared memory partition and a Graphics Processing Unit (GPU) only memory partition; and logic circuitry to perform one or more operations in a protected environment to cause transmission of the stored data from the shared memory partition of the memory to the GPU only memory partition of the memory, wherein the shared memory partition is accessible by both a GPU and a Central Processing Unit (CPU), wherein the GPU only memory partition is only accessible by the GPU. Example 2 includes the apparatus of example 1, wherein execution of the one or more operations in the protected environment is to protect the one or more AI tasks during execution of the one or more AI tasks on the GPU from code to be executed on the CPU. Example 3 includes the apparatus of example 1, comprising logic to encrypt the stored data prior to transmission of the stored data from the shared memory partition of the memory to the GPU only memory partition of the memory. Example 4 includes the apparatus of example 3, wherein the GPU comprises logic to decrypt the encrypted data based on a key to be provided by security logic of the CPU. Example 5 includes the apparatus of example 1, comprising logic to encrypt inference results of the one or more AI tasks. Example 6 includes the apparatus of example 1, wherein encryption or decryption is to be performed based on a symmetric or an asymmetric key. Example 7 includes the apparatus of example 1, wherein the CPU comprises security logic to provide a Trusted Execution Environment (TEE). Example 8 includes the apparatus of example 1, wherein the GPU comprises the logic circuitry. Example 9 includes the apparatus of example 1, wherein the one or more AI tasks correspond to one or more of: parallel processing tasks, compute intensive tasks, encryption or decryption tasks, or Machine Learning or Deep Learning tasks. Example 10 includes the apparatus of example 1, wherein the GPU is a Vector Processing Unit (VPU). Example 11 includes the apparatus of example 1, wherein the GPU or the CPU each comprise one or more processor cores. Example 12 includes the apparatus of example 1, wherein the GPU comprises an AI shader logic to initialize an AI application. Example 13 includes the apparatus of example 12, wherein the AI shader comprises logic to respond to a query corresponding to the one or more AI tasks. Example 14 includes the apparatus of example 1, wherein a System On Chip (SOC) device or a signal integrated circuit device comprises one or more of: the logic circuitry, the memory, and a processor having one or more processor cores. Example 15 includes the apparatus of example 1, wherein an Internet of Things (IoT) device or a vehicle comprises one or more of: the logic circuitry, the memory, and a processor having one or more processor cores. Example 16 includes the apparatus of example 15, wherein the vehicle comprises one or more of: an automobile, a truck, a motorcycle, an airplane, a helicopter, a vessel or ship, a train, or a drone.

Example 17 includes a method comprising: storing data corresponding to one or more Artificial Intelligence (AI) tasks in memory, wherein the memory comprises at least a shared memory partition and a Graphics Processing Unit (GPU) only memory partition; and performing, at logic circuitry, one or more operations in a protected environment to cause transmission of the stored data from the shared memory partition of the memory to the GPU only memory partition of the memory, wherein the shared memory partition is accessible by both a GPU and a Central Processing Unit (CPU), wherein the GPU only memory partition is only accessible by the GPU. Example 18 includes the method of example 17, wherein execution of the one or more operations in the protected environment protects the one or more AI tasks during execution of the one or more AI tasks on the GPU from code to be executed on the CPU. Example 19 includes the method of example 17, further comprising encrypting the stored data prior to transmission of the stored data from the shared memory partition of the memory to the GPU only memory partition of the memory. Example 20 includes the method of example 17, further comprising encrypting inference results of the one or more AI tasks. Example 21 includes the method of example 17, wherein encryption or decryption is performed based on a symmetric or an asymmetric key.

Example 22 includes one or more computer-readable medium comprising one or more instructions that when executed on at least one processor configure the at least one processor to perform one or more operations to: store data corresponding to one or more Artificial Intelligence (AI) tasks in memory, wherein the memory comprises at least a shared memory partition and a Graphics Processing Unit (GPU) only memory partition; and cause performance, at logic circuitry, one or more operations in a protected environment to cause transmission of the stored data from the shared memory partition of the memory to the GPU only memory partition of the memory, wherein the shared memory partition is accessible by both a GPU and the processor, wherein the GPU only memory partition is only accessible by the GPU. Example 23 includes the one or more computer-readable medium of example 22, further comprising one or more instructions that when executed on the at least one processor configure the at least one processor to perform one or more operations to cause encryption of the stored data prior to transmission of the stored data from the shared memory partition of the memory to the GPU only memory partition of the memory. Example 24 includes the one or more computer-readable medium of example 22, further comprising one or more instructions that when executed on the at least one processor configure the at least one processor to perform one or more operations to cause encryption of inference results of the one or more AI tasks. Example 25 includes the one or more computer-readable medium of example 22, wherein execution of the one or more operations in the protected environment protects the one or more AI tasks during execution of the one or more AI tasks on the GPU from code to be executed on the CPU.

Example 26 includes an apparatus comprising means to perform a method as set forth in any preceding example. Example 27 includes machine-readable storage including machine-readable instructions, when executed, to implement a method or realize an apparatus as set forth in any preceding example.

In various embodiments, the operations discussed herein, e.g., with reference to FIG. 1 et seq., may be implemented as hardware (e.g., logic circuitry or more generally circuitry or circuit), software, firmware, or combinations thereof, which may be provided as a computer program product, e.g., including a tangible (e.g., non-transitory) machine-readable or computer-readable medium having stored thereon instructions (or software procedures) used to program a computer to perform a process discussed herein. The machine-readable medium may include a storage device such as those discussed with respect to FIG. 1 et seq.

Additionally, such computer-readable media may be downloaded as a computer program product, wherein the program may be transferred from a remote computer (e.g., a server) to a requesting computer (e.g., a client) by way of data signals provided in a carrier wave or other propagation medium via a communication link (e.g., a bus, a modem, or a network connection).

Reference in the specification to “one embodiment” or “an embodiment” means that a particular feature, structure, and/or characteristic described in connection with the embodiment may be included in at least an implementation. The appearances of the phrase “in one embodiment” in various places in the specification may or may not be all referring to the same embodiment.

Also, in the description and claims, the terms “coupled” and “connected,” along with their derivatives, may be used. In some embodiments, “connected” may be used to indicate that two or more elements are in direct physical or electrical contact with each other. “Coupled” may mean that two or more elements are in direct physical or electrical contact. However, “coupled” may also mean that two or more elements may not be in direct contact with each other, but may still cooperate or interact with each other.

Thus, although embodiments have been described in language specific to structural features and/or methodological acts, it is to be understood that claimed subject matter may not be limited to the specific features or acts described. Rather, the specific features and acts are disclosed as sample forms of implementing the claimed subject matter.

1. An apparatus comprising:
memory store data corresponding to one or more Artificial Intelligence (AI) tasks, wherein the memory comprises at least a shared memory partition and a Graphics Processing Unit (GPU) only memory partition; and
logic circuitry to perform one or more operations in a protected environment to cause transmission of the stored data from the shared memory partition of the memory to the GPU only memory partition of the memory,
wherein the shared memory partition is accessible by both a GPU and a Central Processing Unit (CPU), wherein the GPU only memory partition is only accessible by the GPU.

2. The apparatus of claim 1, wherein execution of the one or more operations in the protected environment is to protect the one or more AI tasks during execution of the one or more AI tasks on the GPU from code to be executed on the CPU.

3. The apparatus of claim 1, comprising logic to encrypt the stored data prior to transmission of the stored data from the shared memory partition of the memory to the GPU only memory partition of the memory.

4. The apparatus of claim 3, wherein the GPU comprises logic to decrypt the encrypted data based on a key to be provided by security logic of the CPU.

5. The apparatus of claim 1, comprising logic to encrypt inference results of the one or more AI tasks.

6. The apparatus of claim 1, wherein encryption or decryption is to be performed based on a symmetric or an asymmetric key.

7. The apparatus of claim 1, wherein the CPU comprises security logic to provide a Trusted Execution Environment (TEE).

8. The apparatus of claim 1, wherein the GPU comprises the logic circuitry.

9. The apparatus of claim 1, wherein the one or more AI tasks correspond to one or more of: parallel processing tasks, compute intensive tasks, encryption or decryption tasks, or Machine Learning or Deep Learning tasks.

10. The apparatus of claim 1, wherein the GPU is a Vector Processing Unit (VPU).

11. The apparatus of claim 1, wherein the GPU or the CPU each comprise one or more processor cores.

12. The apparatus of claim 1, wherein the GPU comprises an AI shader logic to initialize an AI application.

13. The apparatus of claim 12, wherein the AI shader comprises logic to respond to a query corresponding to the one or more AI tasks.

14. The apparatus of claim 1, wherein a System On Chip (SOC) device or a signal integrated circuit device comprises one or more of: the logic circuitry, the memory, and a processor having one or more processor cores.

15. The apparatus of claim 1, wherein an Internet of Things (IoT) device or a vehicle comprises one or more of: the logic circuitry, the memory, and a processor having one or more processor cores.

16. The apparatus of claim 15, wherein the vehicle comprises one or more of: an automobile, a truck, a motorcycle, an airplane, a helicopter, a vessel or ship, a train, or a drone.

17. A method comprising:
storing data corresponding to one or more Artificial Intelligence (AI) tasks in memory, wherein the memory comprises at least a shared memory partition and a Graphics Processing Unit (GPU) only memory partition; and
performing, at logic circuitry, one or more operations in a protected environment to cause transmission of the stored data from the shared memory partition of the memory to the GPU only memory partition of the memory,
wherein the shared memory partition is accessible by both a GPU and a Central Processing Unit (CPU), wherein the GPU only memory partition is only accessible by the GPU.

18. The method of claim 17, wherein execution of the one or more operations in the protected environment protects the one or more AI tasks during execution of the one or more AI tasks on the GPU from code to be executed on the CPU.

19. The method of claim 17, further comprising encrypting the stored data prior to transmission of the stored data from the shared memory partition of the memory to the GPU only memory partition of the memory.

20. The method of claim 17, further comprising encrypting inference results of the one or more AI tasks.

21. The method of claim 17, wherein encryption or decryption is performed based on a symmetric or an asymmetric key.

22. One or more computer-readable medium comprising one or more instructions that when executed on at least one processor configure the at least one processor to perform one or more operations to:
store data corresponding to one or more Artificial Intelligence (AI) tasks in memory, wherein the memory comprises at least a shared memory partition and a Graphics Processing Unit (GPU) only memory partition; and
cause performance, at logic circuitry, one or more operations in a protected environment to cause transmission of the stored data from the shared memory partition of the memory to the GPU only memory partition of the memory,
wherein the shared memory partition is accessible by both a GPU and the processor, wherein the GPU only memory partition is only accessible by the GPU.

23. The one or more computer-readable medium of claim 22, further comprising one or more instructions that when executed on the at least one processor configure the at least one processor to perform one or more operations to cause encryption of the stored data prior to transmission of the stored data from the shared memory partition of the memory to the GPU only memory partition of the memory.

24. The one or more computer-readable medium of claim 22, further comprising one or more instructions that when executed on the at least one processor configure the at least one processor to perform one or more operations to cause encryption of inference results of the one or more AI tasks.

25. The one or more computer-readable medium of claim 22, wherein execution of the one or more operations in the protected environment protects the one or more AI tasks during execution of the one or more AI tasks on the GPU from code to be executed on the CPU.
